(19) United States
(12) Patent Application Publication
(10) Pub. No.: US 2006/0044595 A1
(43) Pub. Date: Mar. 2, 2006

(54) Imaging job monitoring and pipelining

(75) Inventor: Andrew R. Ferlitsch, Tigard, OR (US)

Correspondence Address: Robert D. Varitz;ROBERT D. VARITZ, P.C., 2007 S.E. Grant Street, Portland, OR, 97214, US

(73) Assignee: Sharp Laboratories of America Inc.

(21) Appl. No.: 10/925,602

(22) Filed: Aug. 24, 2004

(51) Int. Cl. G06F 3/12

(52) U.S. Cl. 358/1.15

(57) ABSTRACT

A method for pipelining and monitoring N plural, parallel, different imaging jobs between a client device and a selected imaging device, where each such job, in relation to its execution, is characterizable by N sequential processing states, including at least the states of Transferring, Rasterizing, and Outputting, and the imaging device is capable of performing simultaneously, different jobs each in a different one of such N states. The method includes the steps of (a) creating a main thread associated with the selected imaging device, (b) enabling the spawning, with respect to such created main thread, of up to a total of N child threads each relating to a different job, and (c) utilizing up to a total of N such spawned child threads which are associated with the main thread, implementing parallel job processing between the mentioned devices for up to a total of N plural jobs, wherein different, simultaneously active, spawned and job-specific child threads each has associated with it, at any given point in time, a different, respective N-state of processing for the associated job. The method further enables the simultaneous processing of M×N total different imaging jobs in a circumstance where the selected imaging device is capable of handling M different jobs simultaneously in each of the N different processing states.

### BACKGROUND AND SUMMARY OF THE INVENTION

This invention relates to imaging job monitoring and pipelining. More particularly, it relates to the seriatim pipelining of plural jobs from a host device to a plural-stage imaging device, where the imaging device is capable of performing N different imaging operations (stages) simultaneously, and the number of plural jobs which can be so pipelined and processed simultaneously is N. According to the invention, seriatim pipelining takes place in a manner wherein completion-of-stage-operation notice-giving, delivered effectively from the imaging device to the host device, acts as a signal to the host device to pass a new job from the host device to the imaging device.

While discussion and illustrations given herein reflect numerous operational stages in imaging devices which can be handled by practice of the invention, the usual ever-present core of such operations includes the stages of transferring, rasterizing and outputting.

By way of background introduction, modern MFP devices are increasingly made with the ability to process all, or part of, imaging jobs in parallel. Yet the imaging spooling systems of conventional operating systems, such as the Microsoft Windows® 2K/XP systems, do not support de-spooling and monitoring imaging jobs to output completion in parallel.

Typically, an imaging job is spooled to an imaging spooler, such as a print spooler, and control returns back to the user, who may then continue to perform other work. The spooler handles de-spooling of the imaging job to the imaging device, sometimes referred to herein simply as “device”, as a separate asynchronous process from the spooling process.

The imaging spooler de-spools the imaging job to a port manager. The port manager provides several functions: (1) handling the transport protocol from transmitting the imaging job to the imaging device; (2) handling receiving job notifications on the status of the job/imaging device, and reporting them back to the spooler; and (3) indicating to the spooler when the next job can be de-spooled to the imaging device.

The Microsoft Windows® system is an example of an operating system that uses the above method. In Microsoft Windows® spooler and port monitors, there are several limitations for fully utilizing modern MFPs with parallel processing capabilities. These are:

1. The spooler only de-spools one job at a time through the port monitor until the port monitor reports that the execution of the job was successful (e.g., single job pipelining). Thus:
(a) The spooler/port monitor cannot take advantage of parallel de-spooling jobs to the same device even though the device has the capability and bandwidth to do so; and
(b) The device is limited to processing one job until the device reports completion, and cannot process parts or all of another job during this time since it has not received the next job.

2. Depending on the printing protocol (e.g., LPR), the port manager only monitors the job through completion of the raster image process (RIP) before reporting the success of the job back to the spooler. Thus:
(a) If the device implements an internal job queue, it must report job success after it has internally spooled the job instead of waiting until success of the RIP, so that it can get the host side to initiate de-spooling of the next job for multi-job pipelining; and
(b) Since the device reports success after the completion of the RIP, any error that occurs after the RIP process, such as in outputting, cannot be propagated back to the spooler.

In an improvement to the above situation the network address of a local client is embedded in a print job, and a monitoring process is run in the background on the client machine. When the printer successfully outputs the print job, or detects an error, a message indicating the status of the job is sent back to the monitoring device on the local client machine, such being obtained from the network address in the client machine.

While this improvement enhances job-success reporting back to a host, it still suffers in that the associated methodology is not integrated with the spooler. Therefore, the spooler cannot take advantage of this capability, and all of the earlier-mentioned prior art limitations still exist.

A similar improvement is disclosed in U.S. Pat. No. 6,219,151, where an SNMP trap message for job completion through the outputting process is sent back to a monitoring process on the host that is not integrated with the spooler.

Another example of a similar improvement is disclosed in U.S. Published Pending Patent Application No. 2002/0057449, where an e-mail message for job completion through the outputting process is sent back to a monitoring process that is not integrated with the spooler on a host.

A further example of an improvement offered in the prior art is demonstrated in U.S. Published Patent Application No. 2002/0089692 This publication discloses a method wherein a custom print spooler communicates with a printing device about the status of a print job after it has been despooled to the printing device. Two methods of communication are disclosed.

In the first, the print spooler periodically polls the printing device using SNMP. The printer is presumed to support an SNMP job MIB extension. During each poll, the print spooler queries the printing device for the OID values of a job MIB relating to the de-spooled job.

In the second approach, a custom print spooler registers an SNMP trap with the printing device to respond back with job MIB events. When a job is completed, or when the status otherwise changes, such as in a paper jam, the printing device sends a message back to the custom spooler.

This approach has the advantage in that the job completion through outputting is integrated with the spooler. But the approach still suffers in that it does not disclose taking advantage of any of the parallel processing capabilities of an MFP to de-spool and monitor jobs in parallel. Thus, this prior art approach is still limited to single job pipelining.

In the setting of this prior art background, and given the existing capabilities of imaging devices to handle in parallel plural phases of imaging jobs, there is a desire for an even more effective method for de-spooling and monitoring parallel imaging jobs to imaging devices with internal print queues and/or parallel job processing capabilities.

The present invention, in its preferred and best-mode form, offers an effective method for implementing an imaging spooler (e.g., print spooler) for multijob pipelining and job completion monitoring to final output completion for imaging devices, such as MFP devices, which have parallel job processing capabilities and/or internal print queues. For the purpose of representative illustration herein, the invention is described in relation to an MFP device.

According to implementation and practice of this invention, an appropriately improved MFP device has the following features and capabilities:
1. An internal print queue for holding more than one imaging job;
2. The capability to receive/queue multiple jobs in parallel from the same host computing device;
3. The capability to RIP process multiple imaging jobs in parallel; and
4. The ability to report job status through final outputting on a back channel to the host.

On the host side, an appropriate improved imaging spooler and port monitor have the following capabilities:
1. The port monitor can spawn multiple threads to handle the de-spooling of multiple jobs in parallel to the same imaging device, such as by using a port range to distinguish the jobs, with one port per job;
2. The port monitor can monitor the completion and status of each job in parallel from the spawned threads, and can report the status back the spooler on a per job basis;
3. The imaging spooler can spawn multiple threads to handle the de-spooling of a job while de-spooling another job to the same device when requested to do so by the port monitor; and
4. The imaging spooler can manage the job status and spool data of multiple de-spooled jobs to the same device from the spawned threads.

In addition, the imaging spooler can report information in such a manner, such as to the system registry, that a print monitor can accurately reflect the status of the concurrent processing of jobs to the same device.

In general terms, the present invention can be described as a method for pipelining and monitoring N plural, parallel, different imaging jobs between a client device and a selected imaging device, where each such job, in relation to its execution, is characterizable by N sequential processing states, including at least the states of Transferring, Rasterizing, and Outputting, and the imaging device is capable of performing simultaneously, different jobs each in a different one of such states, where the method includes the steps of:
(a) creating of a main thread associated with the selected imaging device;
(b) enabling the spawning, with respect to such created main thread, of up to a total of N child threads each relating to a different job; and
(c) utilizing up to a total of N such spawned child threads which are associated with the main thread, implementing parallel job processing between the mentioned devices for up to a total of N plural jobs, wherein different, simultaneously active, spawned and job-specific child threads each has associated with it, at any given point in time, a different, respective N-state of processing for the associated job.

From another point of view, the invention can be characterized as a bucket-brigade method for pipelining and monitoring plural, parallel, different imaging jobs between a client device and a plural-stage imaging device, including, for each processing stage, noticing, from the imaging device to the client device, the condition of job-stage completion in the imaging device, and, where the imaging device is enabled at least for (a) notice-buffering an input imaging job, (b) following such buffering, notice-rasterizing that job, and (c) following such rasterizing, notice-outputting the job, and where this method includes the sequence of:
(1) transferring a first imaging job from the client device to the imaging device, and notice buffering it in the imaging device;
(2) notice-rasterizing the notice-buffered first imaging job, and while so rasterizing, simultaneously transferring a second imaging job from the client device to the imaging device and buffering that second imaging job in the imaging device;
(3) notice-outputting the notice-rasterized first imaging job, and while so outputting, simultaneously notice-rasterizing the second imaging job, and transferring a third imaging job from the client device to the imaging device; and thereafter
(4) effectively repeating this bucket-brigade sequence for all immediately next-successive imaging jobs presented to the client device for imaging.

In relation to the detailed description of the invention which shortly follows, that description begins at a high schematic level with reference to FIGS. 1 and 2 in the drawings. From this high level description, those generally skilled in the relevant art will understand fully how to implement and practice the invention. They will also understand that there are numerous detailed ways, all conventional in nature, to accomplish such implementation and practice. For these reasons and except for the several somewhat more specific and representative illustrations given, and described, with respect to FIGS. 3-5, inclusive in the drawings, other details are not set forth herein.

### DESCRIPTION OF THE DRAWINGS

FIG. 1 is a high level block/schematic illustration showing the overall architecture of the methodology of the present invention.

FIG. 2 is an action-describing block/schematic diagram which is useful in relation to FIG. 1 for describing various steps that are performed in the practice of the invention.

FIG. 3 provides a somewhat more detailed host-side view of job pipelining and parallel processing of plural imaging jobs in relation to an internal print queue.

FIG. 4, which is constructed at a detail level similar to that employed in FIG. 3, provides an imaging-device-side view of job-pipeline and parallel RIP processing in relation to reception from an internal print queue.

FIG. 5 illustrates a practice of serial outputting from a RIP queue.

### DETAILED DESCRIPTION OF THE INVENTION

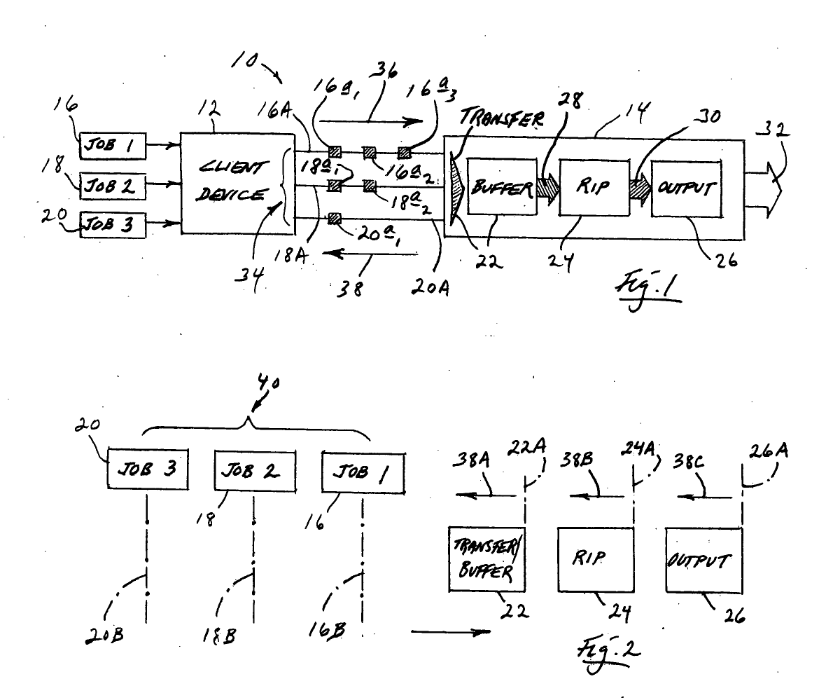

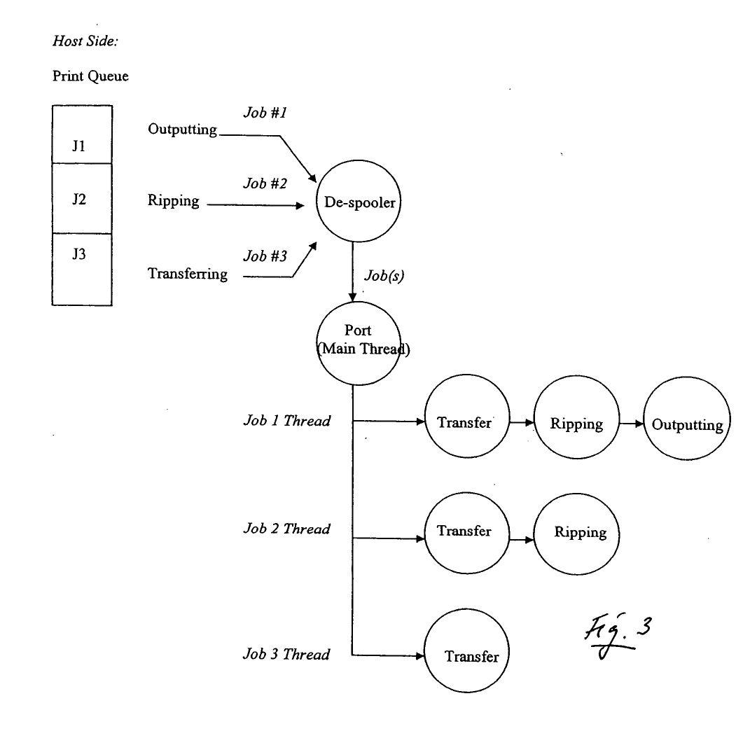

Referring first to FIGS. 1 and 2, shown generally at 10 in FIG. 1 is a high-level schematic illustration of the architecture of the methodology of the present invention. In FIG. 1, a block 12 represents a host computer, or host, or client device, a block 14 represents an imaging device, such a an MFP device, and blocks 16, 18, 20 represent three imaging jobs labeled, respectively, “Job 1”, “Job 2” and “Job 3”. For the purpose of illustration herein, it will be assumed that these three jobs have been requested in the serial order of 16, 18, 20, and that FIG. 1 can be used both to describe the serial response and behavior of this invention in relation to that job request order, and also to illustrate a moment in time wherein all three jobs are being handled/processed simultaneously (in parallel) in three different, specific processing states referred to herein (a) as transferring/buffering, (b) raster image processing (or rasterizing, RIP), and (c) outputting. Sub-block 22 (along with an associated, broad shaded arrowhead indicated by the same reference numeral), and sub-blocks 24, 26, all shown within block 14, represent these three, respective processing states. Processing flow between states 22, 24 is represented by a broad, shaded arrow 28, and flow between processing states 24, 26 is represented by a broad, shaded arrow 30. Final job output is represented in FIG. 1 by a broad, unshaded arrow 32.

Associated with host 12 in relation to its cooperative job-handling interaction with device 14, and well understood by those skilled in the art, is a main thread which is represented by a bracket 34. For each of jobs 16, 18, 20, there is an associated, and also well understood spawned child thread 16A, 18A, 20A, respectively, which has been appropriately spawned by main thread 34. Associated with each of these three child threads is/are one or more small shaded squares. Three such squares 16a₁, 16a₂ 16a₃ are associated with child thread 16A. Two such squares, 18a₁, 18a₂ are associated with child thread 18A. One such square, 20a, is associated with child thread 20A. These squares represent the respective, different processing states (transferring, rasterizing and outputting), which have been associated with child threads 16A, 18A, 20A, and thus with jobs 16, 18, 20, at the moment in time which is represented in FIG. 1, and a process which is referred to herein as notice-giving. More will be said about this shortly.

Completing a description of what is shown in FIG. 1, a right-pointing arrow 36 represents the flow of job-handling instruction, etc. data from host 12 to device 14, and left-pointing arrow 38 represents the notice-giving process briefly mentioned above.

Turning attention now to action-illustrating FIG. 2 which links directly with FIG. 1, it will be useful to visualize bracket 40 as representing the collection of the three previously mentioned imaging jobs, 16, 18, 20, and that these jobs, beginning with job 16, are moving to the right in FIG. 2, as “cursors”, toward previously mentioned processing states 22, 24, 26 which are represented, respectively, by three appropriate, laterally spaced blocks 22, 24, 26 in this figure. Dash-dot lines 16B, 18B, 20B which depend from the three blocks in FIG. 2 that represent jobs 16, 18, 20, respectively, specifically are intended to represent such “cursors”. The direction of job instructional flow is represented in FIG. 2 by previously mentioned arrow 36.

Extending upwardly from the right-hand sides of block 22, 24, 26 in FIG. 2 are three dash-dot lines 22A, 24A, 26A, respectively, and pointing to the left in this figure from these three lines are arrows 38A, 38B, 38C, respectively. Lines 22A, 24A, 26A represent the end points of processing performed in processing states 22, 24, 26, respectively. Arrows 38A, 38B, 38C collectively represent “components” of previously mentioned arrow 38, and individually represent report-back notice-giving, on an imaging-job-by-imaging-job basis, regarding the completions (lines 22A, 24A, 26A) of the processing functions performed in blocks 22, 24, 26, respectively.

In terms of the physical layout of drawing elements in FIG. 2, and while dimensionality is not absolutely precise, it is intended that the lateral spacings existing between adjacent “cursors” 16B, 18B, 20B be the same substantially as the lateral spacings between lines 22A, 24A, 26A.

Describing the various activities which are “pictured” in FIG. 2 in the analogy language of cursor movement, and imagining now that job cursors 16B, 18B, 20B are moving to the right (as a block of cursors) in FIG. 2, cursor 16B (associated with imaging job 16) is the first to engage one of the processing-state blocks, and specifically engages transferring/buffering block 22 (first processing state). This “engagement” initiates data transfer from host 12 to imaging device 14. Child thread 16A is spawned to be in association with job 16.

When cursor 16B reaches the right side of block 22, and thus the location of line 22A which represents the end of the processing state of transferring/buffering for job 16, a return-back notice (arrow 38A) goes to child thread 16A to “update” its status (small square 16a₁ in FIG. 1), thus to indicate that imaging device 14 is no longer engaged in transferring/buffering processing. This notice-giving action, in conjunction with the data transferring and buffering operation, is referred to herein as notice-buffering. Device 14 is now again in a condition to engage in a transferring/buffering processing state. This clears the way for job 18 to begin to be handed off from host 12 to device 14, with child thread 18A then spawned by main thread 34.

Cursor 16B next “engages” RIP (raster image processing) block 24, and at substantially the same moment in time, because of the fact that, in the illustration now being given, three jobs are all in line for processing, cursor 18B (associated with job 18) engages transferring/buffering block 22. Thus, RIP processing (a second state of processing) begins in device 14 for job 16, and transferring/buffering processing (first state) begins for job 18. As the “cursors” continue to move to the right in FIG. 2, device 14 is now engaged in two simultaneous, but different, processing states for two successive imaging jobs.

When cursor 16B reaches end-of-processing line 24A, a return-back notice (arrow 38B) goes to child thread 16A to update its status (small square 16a₂ in FIG. 1) thus to indicate that device 14 is no longer engaged in RIP processing, and is once again free to “offer” this state of processing to another job. This RIP processing and notice giving is referred to herein as notice-rasterizing.

Cursor 18B reaches end-of-processing line 22A at about the same time, and a return-back notice (arrow 38A) goes to child thread 18A to update its status (small square 18a₁ in FIG. 1), thus to indicate that again device 14 has a free and available transferring/buffering processing state for a next imaging job.

From this point forward, cursor 16B engages output (or outputting) processing block 26 (third processing state), cursor 18B engages RIP processing block 24, and cursor 20B (associated with job 20) engages transferring/buffering block 22. When this occurs, device 14 is then engaged in implementing three simultaneous, but different, processing states with three different jobs.

When cursor 16B reaches end-of-processing line 26A, a return-back notice (arrow 38C) goes to child thread 16A to update its status (small square 16a₃ in FIG. 1), thus to indicate that device 14 again has a free output processing state. This activity is referred to herein as notice-outputting.

At about the same time, cursor 18B reaches end-of-processing line 24A, and a return-back notice (arrow 38B) goes to child thread 18A to update its status (small square 18a₂ in FIG. 1), thus to indicate that device 14 once again has a free RIP processing state to accommodate another imaging job.

Further, cursor 20B reaches end-of-processing line 22A, and a return-back notice (arrow 38A) goes to child thread 20A to update its status (small square 20a₁ in FIG. 1), thus to indicate that device 14 now again has a free transferring/buffering processing state.

As each imaging job is fully completed, its associated child thread is destroyed or released into a thread pool for reuse.

Thus, a description of FIG. 2, which fully states the operation of the present invention, is complete. This description, one will note, has been given in the context of an imaging device (device 14) having the capability of offering, simultaneously, different-job processing in three different states. Accordingly, it should be understood that where the letter-character, or variable, N is used herein, N=3 in the specific case of the just-given illustration of the practice of the present invention. In the given illustration, where device 14 is capable of handling N=3 simultaneously imaging jobs, up to N=3 child threads, spawned by the main thread, can exist at any moment in time. The main thread constantly monitors the “conditions” and “presences” of child threads to determine when it can next spawn another child thread to accommodate a new imaging job.

The somewhat more detailed text which now immediately follows is given in relation to the remaining drawing FIGS. 3-5, inclusive, which figures are seen to be quite self-explanatory. Side headings in this next text are used to identify specific practice portions of the invention.

Parallel De-Spooling to the Same Device

Referring to FIG. 3, in this illustrated portion of the invention, an imaging spooler (e.g., print spooler) creates a main thread per device. Each main thread can further spawn additional child threads. The spooler maintains an imaging queue (e.g., print queue) of jobs spooled to a device for each device. The spooler also maintains a status of each job in the queue, including, but not limited to:
1. Spooling—the job is currently being spooled to the spooler;
2. Spooled—the job is fully spooled to the spooler;
3. De-spooling—the job is being transferred to the device via the port monitor;
4. Queued—the job is queued in the device;
5. Processing—the job is being processed by the device; and
6. Outputting—the result of the job (e.g., printed sheets) is being outputted from the device.

The port monitor used for de-spooling the imaging job from the host to the device spawns a child thread for each concurrent imaging job to the device.

When a job is in a spooled state and no other jobs are being de-spooled by the port monitor, the imaging spooler spawns a child thread associated with the device and initiates the de-spooling of the job to the port monitor. Upon initiating, the spooler updates the jobs status to de-spooling.

Upon receipt of the de-spooling request from the imaging spooler, the port monitor spawns a child thread for de-spooling the imaging job to the imaging device.

The child thread in the port monitor has several processes associated with the job:
1. De-spooling;
2. Queued;
3. Processing; and
4. Outputting.

Upon initiation, the imaging job goes to the de-spooling process which de-spools the imaging job to the imaging device. When the job has been fully de-spooled to the device (i.e., when the device acknowledges receipt of the last byte of the job), the job moves into the queued process. The queued process of the port monitor's child thread then sends a message back to the corresponding thread in the imaging spooler that the job is now queued. The imaging spooler then updates the status of the imaging job to queued.

The job moves from the queued process to the processing process when the port monitor receives a message (e.g., back channel) from the device that processing (e.g., RIP processing) has begun on the job. The processing process of the port monitor's child thread then sends a message back to the corresponding thread in the imaging spooler that the job is now processing. The imaging spooler then updates the status of the imaging job to processing.

The job moves from the processing process to the outputting process when the port monitor receives a message from the device that the processing has completed the job. The outputting process of the port monitor's child thread then sends a message back to the corresponding thread in the imaging spooler that the job is now outputting. The imaging spooler then updates the status of the imaging job to outputting.

The job stays in the outputting process until the port monitor receives a message from the device that the outputting has completed on the job. The outputting process of the port monitor's child thread then sends a message back to the corresponding thread in the imaging spooler that the job has completed outputting. The port monitor's child thread is then terminated or released into a thread pool for reuse. The imaging spooler then updates the status of the imaging job to outputted. The associated child thread in the imaging spooler is then terminated.

If an error occurs during any of the port monitor's processes, the error is reported back to the imaging spooler, the port monitor's child thread is terminated, and the imaging spooler takes corrective action, if any.

In a somewhat modified approach, the port monitor's child thread is not immediately terminated on error. Instead, the corresponding thread in the print spooler and port monitor's child thread coordinates a corrective action, which could include aborting the action and terminating of the port monitor's child thread.

Once a job in the port monitor's child thread has reported back to the spooler that the job is in a queued state, the imaging spooler may start to scan the queue for another job in a spooled state for concurrent de-spooling.

If another job is ready for de-spooling, the spooler attempts to initiate the concurrent de-spooling of the job to the port monitor associated with the device. Upon receipt of the request to de-spool, the port monitor creates another child thread for the new job. The port monitor's child thread attempts to connect to the device using a unique connection, such as the next port number in a port range.

If the attempt to connect to the device concurrently fails, the port monitor's child thread rejects the request from the spooler to initiate the de-spooling and terminates the child thread. The child thread in the spooler then periodically re-attempts to initiate the request for de-spooling of the job.

If the attempt to connect to the device concurrently succeeds, the child thread in the port monitor accepts the request from the spooler and initiates the concurrent de-spooling of the job to the device. The actions of moving the job through the various processes are the same as described above for the single job.

In a modified approach, if the imaging device does not have an internal queue and can only implement serial pipelining, it may still parallel process jobs. If the port monitor is aware that the imaging device lacks this capability (e.g., such as being communicated to it by the device via a back channel), the port monitor will not create a new child thread and attempt to open a concurrent connection to the device until the first job has entered, or proceeded past, the processing state.

Parallel RIP Processing Within the Device

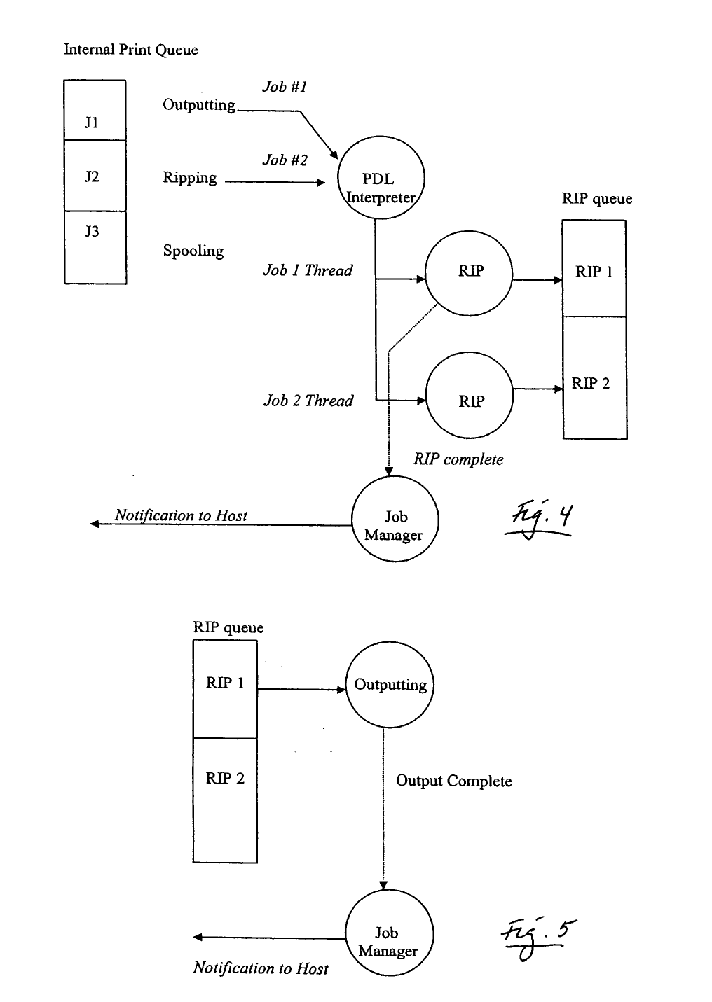

Looking now at FIG. 4, the imaging device maintains an internal job queue for handling multiple jobs. An internal spooler handles the management of these jobs within the imaging device. The internal spooler maintains a status of each job in the internal queue, as, but not limited to:
1. Spooling—the device is receiving a job;
2. Spooled—a job has been fully received by the device;
3. Processing—the device has started processing the job;
4. RIPping—the device has started raster image processing of the job;
5. Processed—the device has completed the processing of the job; and
6. Outputting—the device has completed processing of the job and is in the final stages of outputting the job.

When a job is in a spooled state and no other jobs are being processed by the device, the internal spooler spawns a child thread associated with the job and initiates the processing of the job. In a modified approach, the internal spooler may initiate the processing of a job in a spooling state, if the device supports streaming and sufficient data has been spooled to start the processing.

The child thread has three processes associated with the job:
1. Page Description Language (PDL) interpretation;
2. Raster Image Processing (RIP); and
3. Outputting.

Typically, initiation includes sniffing the job's data stream to determine the data type and passing the job to a PDL interpretation process that corresponds to the data type. The PDL interpretation process of the internal spooler's child thread then sends a message back (e.g., back channel) to the corresponding thread in the host side port monitor that the job is now processing. The internal spooler then updates the internal status of the imaging job to processing.

In another manner of practice, the job data type is a device independent image data. In this case, the job bypasses the PDL interpretation process and proceeds to the RIP process. In still another manner of practice, the job data type is device dependent raster data. In this case, the job bypasses both the PDL interpretation and RIP processes and proceeds to the outputting process.

The PDL interpretation process converts the job data into images on an outputting boundary (e.g., bands, pages, sheets). Once all the job data is converted to images, the images are passed to the RIP process. Upon initiation of the RIP process, the internal spooler's child thread then sends a message back to the corresponding thread in the host side port monitor that the job is now RIP processing. The internal spooler then updates the internal status of the imaging job to RIP processing.

In an alternate approach, images are passed to the RIP process as they are produced. (i.e., streaming).

The RIP process converts the images into a device specific format for outputting (i.e., raster) and places the raster images into the internal RIP queue. When the RIP process completes, the internal spooler's child thread sends a message back to the corresponding thread in the host side port monitor that the job has completed the RIP and updates the internal status of the imaging job to processed.

If an error occurs during any of the internal spooler's processes, the internal spooler may attempt to take corrective action, if any. If the internal spooler is unable to take corrective action, the error is reported back to the corresponding thread in the host side port monitor, and the internal spooler's child thread is terminated.

In a modified implementation, the internal spooler's child thread is not immediately terminated on error. Instead, the corresponding thread in the host side port monitor's child thread coordinates a corrective action, which could include aborting the action and terminating of the internal spooler's child thread.

Once a job in the internal queue has started processing, the internal spooler may start to scan the queue for another job in a spooled (or spooling) state for concurrent processing.

If another job is ready for processing, the internal spooler attempts to initiate the concurrent processing of the job. The internal spooler creates another child thread for the next job. The internal spooler's child thread attempts to initiate the PDL interpretation process associated with the job data type.

Upon attempting to initiate this process, the internal spooler determines if there is sufficient resources available for concurrent processing. If not, the internal spooler terminates the child thread. The internal spooler then periodically re-attempts to initiate the processing of the job.

If there are sufficient resources to process the next job concurrently, the internal spooler's child thread initiates the concurrent processing of the job. The actions of moving the job through the various processes are the same as described above for the single job.

Serial Output Completion from Device to Host

Turning finally to FIG. 5, when a job is fully queued in the RIP queue, the internal spooler then starts the outputting process. Typically, the outputting process is done on a serial manner (i.e., one job at a time) per outputting channel (e.g., media path through he fuser/developer in a printer). In an alternate embodiment, concurrent job outputting may be multiplexed through the same outputting channel. In another approach, concurrent job outputting may be accomplished through plural outputting engines having different outputting paths. Upon initiation of the outputting process, the internal spooler's child thread sends a message back to the corresponding thread in the host side port monitor that the job is now outputting. The internal spooler then updates the internal status of the imaging job to outputting.

As an alternate, the internal spooler may start the outputting process before the job is fully queued to the RIP queue, if there is sufficient raster images to initiate the outputting process (i.e., streaming).

When the outputting process is completed, the internal spooler's child thread then sends a message back to the corresponding thread in the host side port monitor that the job is now outputted (i.e., completed). The internal spooler then updates the internal status of the imaging job to outputted and the child thread is terminated.

Thus the present invention uniquely offers the opportunity to take advantage of the capability of an imaging device to engage simultaneously in plural processing states. In this setting, if the number of such states has the value N, then practice of the invention allows for the simultaneous processing of N total, different imaging jobs.

In a more advanced situation, where an imaging device has N processing states that can occur simultaneously, and additionally is capable of handling M different jobs in each such state, then it is possible, in the practice of this invention, to process M×N simultaneous, different imaging jobs.

Accordingly, while a preferred and best-mode implementation of the invention has been described, and a number of modifications and variations identified and suggested, it will be apparent to those skilled in the art that other variations and modifications are possible which will clearly come within the scope of the invention.

I claim:

1. A method for pipelining and monitoring N plural, parallel, different imaging jobs between a client device and a selected imaging device, where each such job, in relation to its execution, is characterizable by N sequential processing states, including at least the states of Transferring, Rasterizing, and Outputting, and the imaging device is capable of performing simultaneously, different jobs each in a different one of such N states, said method comprising
creating of a main thread associated with the selected imaging device,
enabling the spawning, with respect to such created main thread, of up to a total of N child threads each relating to a different job, and
utilizing up to a total of N such spawned child threads which are associated with the main thread, implementing parallel job processing between the mentioned devices for up to a total of N plural jobs, wherein different, simultaneously active, spawned and job-specific child threads each has associated with it, at any given point in time, a different, respective N-state of processing for the associated job.

2. The method of claim 1, wherein an imaging device is one which is capable of performing an imaging operation drawn from the group including printing, faxing, scanning, copying, web publishing, document managing, document archiving and retrieving, document manipulation and document transfer.

3. The method of claim 1, wherein an imaging device is one which is capable of processing M different imaging jobs simultaneously in each of such N states, and thus is capable of handling simultaneously M×N different imaging jobs.

4. A bucket-brigade method for pipelining and monitoring plural, parallel, different imaging jobs between a client device and a plural-stage imaging device including noticing, from the imaging device to the client device, job-stage completion in the imaging device, and where the imaging device, with respect to noticing, is enabled at least for (a) notice-buffering an input imaging job, (b) following such buffering, notice-rasterizing that job, and (c) following such rasterizing notice-outputting the job, said method comprising the sequence of
transferring a first imaging job from the client device to the imaging device, and notice-buffering it in the imaging device,
notice-rasterizing the notice-buffered first imaging job, and while so rasterizing, simultaneously transferring a second imaging job from the client device to the imaging device, and notice-buffering that second imaging job in the imaging device,
notice-outputting the notice-rasterized first imaging job, and while so outputting, simultaneously notice-rasterizing the second imaging job, and transferring a third imaging job from the client device to the imaging device,
and thereafter effectively repeating this bucket-brigade sequence for all immediately next-successive imaging jobs presented to the client device for imaging.

5. The method of claim 4, wherein an imaging device is one which is capable of performing an imaging operation drawn from the groups including printing, faxing, scanning, copying, web publishing, document managing, document archiving and retrieving, document manipulation and document transfer.
